(19) United States
(12) Patent Application Publication
(10) Pub. No.: US 2006/0177114 A1
(43) Pub. Date: Aug. 10, 2006

(54) Medical digital asset management system and method

(76) Inventors: Trongtum Tongdee, St. Louis, MO (US); Vamsidhar R. Narra, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 11/081,254

(22) Filed: Mar. 16, 2005

Related U.S. Application Data
(60) Provisional application No. 60/651,253, filed on Feb. 9, 2005.

(51) Int. Cl. G06F 17/00; G06K 9/00

(52) U.S. Cl. 382/128; 707/104.1

(57) ABSTRACT

A system and method for managing digital medical images includes retrieving one or more digital medical images from among a plurality of digital medical image files having medical images formatted in two or more different image file formats. A working copy image of each of the retrieved digital medical images is created, one or more working copy images are displayed, and one or more displayed images are edited responsive to an input from an operator such that the displayed images include the edits. Text data associated with one or more edited images is received. A directory is automatically created in a database associated with the one or more edited images and the text data and an XML file and an HTML file are automatically created and associated with the directory. The edited images, the text data, the XML file, and the HTML file are stored in the directory.

### CROSS-REFERENCE TO RELATED APPLICATIONS

This application claims the benefit of U.S. Provisional Application No. 60/651,253, filed on Feb. 9, 2005. The disclosure of the above application is incorporated herein by reference.

### FIELD OF THE INVENTION

The present invention relates to digital asset management systems and more specifically relates to software systems and computer-assisted methods for managing digital image assets.

### BACKGROUND

The storage and management of assets in digital form is a fundamental need for many businesses and professionals today. By way of example, the storage and management of digital assets related to patient information such as images, proprietary patient identification data, diagnostic records, office visit notes, audio notations to records, and audio-video files, has gained increased adoption within various medical disciplines, research facilities and healthcare facilities.

These digital assets, when shared with other personnel over geographically dispersed facilities, are often transmitted electronically over public and private networks with the information content encrypted to preserve the security of the information and protect patient data. When digital assets, such as digital images, are received and displayed by recipients of the information, related identification data is often disclosed with the received images. Digital data or records can be distributed as file attachments to emails that are directed to other professionals, stored on portable media for subsequent distribution, or stored on web sever databases accessible by the Internet.

Once digital assets have been securely protected, the digital assets can also be used for other purposes such as a teaching aid or for presentation. Professionals, in the course of managing their individual practices, create their own personal databases of digital assets such as patient images and information.

Digital assets such as images can originate from various image scanning sources or modalities. For example, in the medical field these can include x-rays, ultrasound (US), computerized tomography (CT) scans, positron emission computed tomography (PET) scans, magnetic resonance imaging (MRI) scans and nuclear medicine images (NM) that use chemically radioactive agents. These digital assets are electronically processed/sourced, stored, and retrieved by professionals for viewing at workstations equipped to view, process and manage the stored information.

### SUMMARY

The inventors of the various embodiments of the invention have designed a system and process for enabling users to access a wide variety of digital assets with computer-based software and to further process the medical digital assets. This can include digital asset management and utilization of the digital assets for storage, retrieval, manipulation, and auxiliary applications. The inventors have designed embodiments of the invention to leverage the access to medical digital assets, facilitate the additional processing of these assets and provide tools to a user to create multi-media presentation materials that can be electronically stored for later use such as use in a presentation or as an educational material or exchange with other parties or applications.

According to one aspect of the invention, a system and method for managing digital medical images includes retrieving one or more digital medical images from among a plurality of digital medical image files having medical images formatted in two or more different image file formats. A working copy image of each of the retrieved digital medical images is created, one or more working copy images are displayed, and one or more displayed images are edited responsive to an input from an operator such that the displayed images include the edits. Text data associated with one or more edited images is received. A directory is automatically created in a database associated with the one or more edited images and the text data and an XML file and an HTML file are automatically created and associated with the directory. The edited images, the text data, the XML file, and the HTML file are stored in the directory.

According to another aspect of the invention, a system for managing digital medical images includes a general purpose computing device and a computer program that includes program modules executable by the computing device. The program modules include a digital database module for automatically creating and maintaining a database containing a plurality of directories. Each of the directories has a plurality of associated files including a digital medical image file containing one or more digital medical images, an XML file, and an HTML file. The plurality of directories includes a plurality of digital medical images formatted in two or more different image file formats. An image display and edit module provides for displaying at least one digital medical image retrieved from the digital database module, editing the at least one displayed image in response to input from an operator, and generating an output file including one or more of the edited images. A digital imaging and communication in medicine (DICOM®) server module provides for reading and composing DICOM® compliant formatted files, and retrieving and storing images and text contained therein.

According to yet another aspect of the invention; a computer readable medium having computer executable instructions for performing a method that includes retrieving one or more digital medical images from among a plurality of digital medical image files having medical images formatted in two or more different image file formats. The method includes creating a working copy image of each of the retrieved digital medical images, displaying one or more working copy images, and editing at least one displayed image responsive to an input from an operator, wherein the displayed image includes the editing. Text data associated with the edited image is received. The method also includes automatically creating a directory in a database related to the edited image and automatically generating an XML file and an HTML file associated with the directory. The method further includes storing the edited images, the text data, the XML file, and the HTML file in the directory.

According to still another aspect of the invention, a general purpose computing device including a display and user input device and a computer program including computer executable instructions configured for retrieving one or more digital medical images from among a plurality of digital medical image files. The digital medical image files having medical images formatted in two or more different image file formats, one of which is a digital imaging and communication in medicine (DICOM®) formatted file. The computer executable instructions also includes instructions for creating a working copy image of each of the retrieved digital medical images, displaying at least one digital medical images, and editing one or more displayed images responsive to an input from an operator. The instruction also are for receiving text data associated with one or more edited images including data from a DICOM® formatted file and automatically creating a directory in a database associated with the one or more edited images and the text data. The instructions further includes automatically generating an XML file and an HTML file associated with the directory, and storing the edited images, the text data, the XML file, and the HTML file in the directory.

Further aspects of the present invention will be in part apparent and in part pointed out below. It should be understood that various aspects of the invention may be implemented individually or in combination with one another. It should also be understood that the detailed description and drawings, while indicating certain exemplary embodiments of the invention, are intended for purposes of illustration only and should not be construed as limiting the scope of the invention.

### BRIEF DESCRIPTION OF THE DRAWINGS

FIG. 1 is a block diagram of a digital image asset management system process according to one exemplary embodiment of the invention.

FIG. 2 is a block diagram of a digital image asset management system process according to another exemplary embodiment of the invention.

FIG. 3 is a block diagram of a digital image asset management system process according to yet another exemplary embodiment of the invention.

FIG. 4 is a block diagram of a digital image asset management system process according to still another exemplary embodiment of the invention.

FIG. 5 is block diagram of digital image asset management system according to one exemplary embodiment of the invention.

FIG. 6 is a block diagram illustrating a software module architecture for a digital image asset management system according to one exemplary embodiment.

FIG. 7 is a flow diagram of a database hierarchy and process flow for a digital image asset management system according to another one exemplary embodiment.

FIG. 8 is a flow diagram of a database search process for a digital image asset management system according to one exemplary embodiment of the invention.

FIG. 9 is a flow diagram of a database management process for a digital image asset management system according to one exemplary embodiment.

FIG. 10 is a flow diagram of a process for exporting to a presentation application for a digital image asset management system according to another exemplary embodiment of the invention.

FIGS. 11A and 11B are flow diagrams of encryption and decryption processes, respectively, for a digital image asset management system according to one exemplary embodiment of the invention.

FIG. 12 is a block diagram of a computer system that can be used to implement a method and/or system for digital medical image management according to one exemplary embodiment of the invention.

Like reference symbols indicate like elements or features throughout the drawings.

### DETAILED DESCRIPTION OF PREFERRED EMBODIMENTS

The following description is merely exemplary in nature and is in not intended to limit the invention, its applications, or uses.

A system and method of managing digital image assets that includes retrieving one or more digital images from among a plurality of digital image files having images formatted in two or more different image file formats. A working copy image of each of the retrieved digital images is created and one or more working copy images are displayed. One or more displayed images are edited in response to an input from an operator and the edits are included in the displayed images. The method also includes receiving text data associated with one or more edited images. A directory is automatically created in a database and associated with the one or more edited images and the text data and an XML file and an HTML file associated with the directory are automatically created. The method further includes storing the edited images, the text data, the XML file, and the HTML file in the directory.

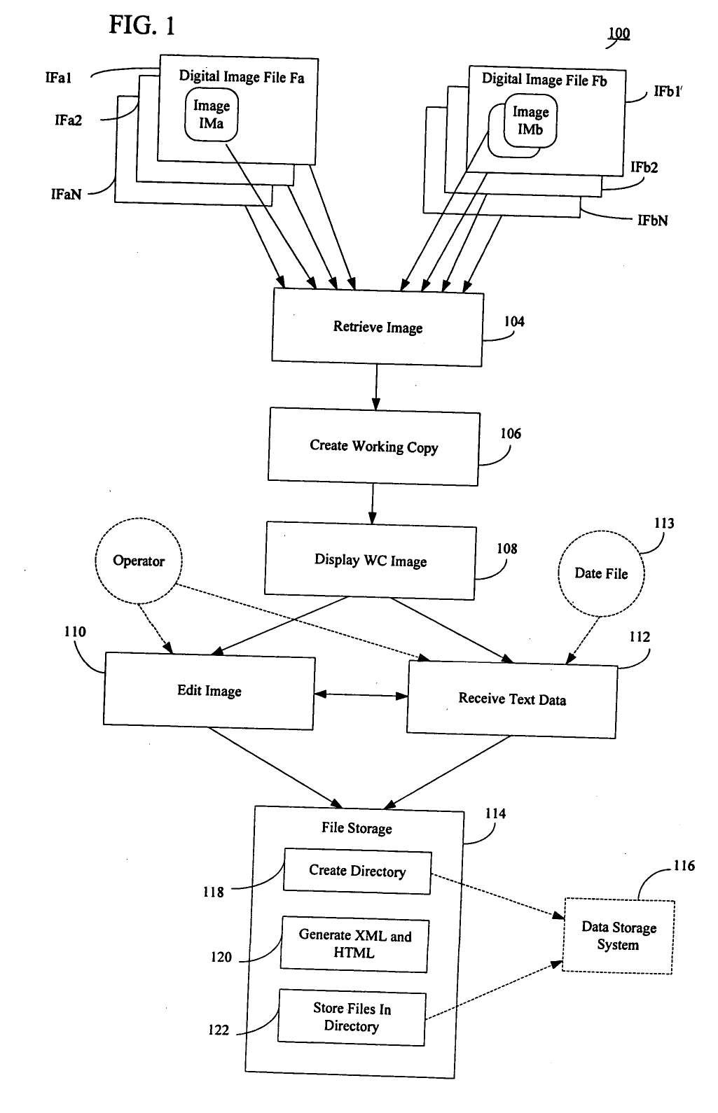

Referring to FIG. 1, a digital image management system method 100, according to one embodiment of the invention starts with two or more digital images IM that have two or more image formats, illustrated as IMa, IMb, wherein the a and b indicate the image format. The image formats can include JPEG, PNG, PSD, BMP, TIFF, DICOM®, DICOM® secondary capture, Multiframe DICOM®, and Microsoft PowerPoint®, by way of example only. Other image file formats are also possible including PDF and Run-Length Encoding, other older and/or proprietary formats such as Analyze, ECAT, exDICOM®, Genesis, Interfile, Magnetom, Somatom™, NEMA, or future image file formats that have yet to be created or implemented. These images IMa, IMb are stored in image files such as files IFa1, IFa2, . . . IFaN that relate to the first image file format and files IFb1, IFb2, . . . IFbN, that relate to the second image file format. One or more of these images IM or image files IF may be contained in one or more digital memory or storage systems or medium. One or more of the images IM are retrieved by the process in 104 and a working copy of each retrieved image is creates in 106. In this manner, the retrieved image or image file is not utilized or displayed to an operator.

The working copy image is displayed on a display to an operator in 108. The operator utilizes the digital image management system to edit the image in 110 or to enter, attached, or copy and paste text data into a text file associated with the displayed image and or the image edits. The image editing can include any type of editing, and may include, by way of example, erasing a portion or portions of the image, inserting text, adding pointers to the image, adding lines, filling in portions or sections, highlighting portions of the image, measuring one or more features of the image, changing an image color, or cropping a portion of the image.

The system and process receive operator input from any type of operator or communication interface configured to receive text data. These can include a keyboard, a mouse, a scanner, a pointing device, a touch pad, a communication link, and/or a physical transducer such as a microphone. A data file 113 can also be utilized for receiving text data. Such a data file may be a separate file or one that is associated with one or more of the retrieved images IM or image file IF. In one embodiment, the text data may be received as a tag or as metadata when the image IM or the image file IF is retrieved. By way of example only, in one medical image application of the method, one or more retrieved images IMn or image files IFn can be a DICOM® file that includes a DICOM® file tag including text. In such an embodiment, receiving text data in 112 can include extracting the text data from the DICOM® file tag.

In some embodiments, one or more image files can also be associated with text within a text file. While as described above the text data can be associated with one or more images, an image file such as a PDF or other file format as described above, can be associated with text or a portion of text. For example, a portion of text data can be highlighted by an operator and one or more PDF or other image files can be associated with the highlighted text. In one embodiment, this association can be similar to a footnote or endnote type association that enables the originator to associate the additional image with a portion of the text and therefore enabling a later viewer to review an image, read the associated text, and then also view another image such as a PDF that is further associated with a portion of the text. Such a text-linked image can also be saved and managed by the system in a similar manner as to the other images and/or the text.

One or more edited image and associated text data, as well possibly, as the originally retrieved image or image file is stored by the system and process in a file storage process in 114. This can include storing the various files associated with the edited image and the associated text data in a data storage system 116 that may be a local data store or may be a data store remote from the system and/or operator. The file storage includes automatically creating a directory in a database in 118 for the one or more files associated with the particular or group of edited images, text data, and possibly the originally retrieved image. An XML file and an HTML file are automatically generated in 120 based on the associated edited image and text data files. In 122, the edited image file or files are stored in the directory of the database along with the associated text data, the XML file, and the HTML file. In some embodiments, the retrieved image can also be stored in the directory for reference or historical purposes, or otherwise. Each edited image file may be stored as a separate image file with the directory or one or more edited images or working copy images can be combined together (not shown) and stored as a single image file in the directory in 122. Each stored edited or other image can be stored in its native file format (native as in the format of the retrieved image) or one or more of the images can be converted to a second format prior to storing in 122.

Generally, the retrieved and edited digital images may be any type of image available in a digitized format, including both single as well as multiple frame images. By way of example, in one exemplary embodiment, the images may be medical images such as an XRAY, an MRI, a CT scan, a Nuclear Medicine study, an ultrasound scan, a laser scan, a PET scan, an endoscope image, a microscope image, an electron microscope image, an electrocardiogram (EKG), an electro encephalogram (EEG), and electro myogram (EMG), audiometry/audiogram, and an optical scan. In other embodiments, the images may be any image includes, but not limited to graphic art, art, camera, computer generated, satellite, infrared, radio scope, and telescope images.

These images can be associated with any type of operator, industry, or function. For example, some exemplary operators can include, but are not limited to, medical, marketing, sales, analysts, real estate agents, broadcasters, scientists, engineers, lawyers, executives, managers, officers, soldiers, teachers, and students. As one further more detailed example related to operators associated with medical images, the operator can include, or be associated with, a radiologist, a radiation oncologist, a cardiologist, an oncologist, a surgeon, a dermatologist, a pathologist, an internist, a medical researcher, a pharmacist, a dentist, an ophthalmologist, a drug developer, a physician, and a medical student.

Similarly, the text data can be any type of text data, but is generally text data associated with the type of operator and the type of images. This can include, by way of example, test data, engineering data, architecture data, sales data, diagnostic data, marketing data, real estate data, legal data, educational data, military data, intelligence data, sensing data, sports data, investment data, entertainment data, medical data, and research data. For example, where the text data is medical data, the text data can include patient data, case data, subject data, test data, diagnostic data, DICOM® data, and research data.

As shown in FIG. 1, the system and process for digital image management provides for management of a plurality of images and the automated generation of a directory and web-context files along with associated text data. Such a system and process can provide a simplified, robust and highly automated user interface and tool for managing digital images which are valuable assets to many professionals and businesses.

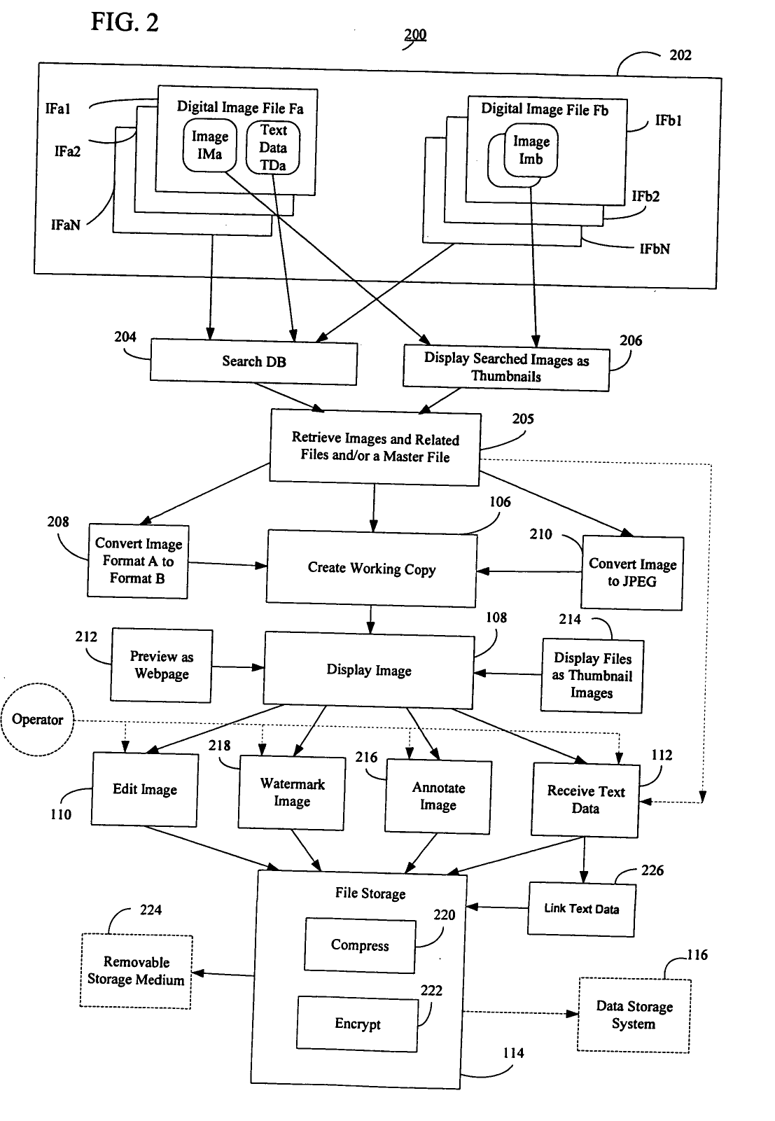

FIG. 2 is another exemplary embodiment of a digital image management system 200, which is similar to system 100 of FIG. 1, but includes a variety of other features and functionality, some or all of which can be present in one form or another in various embodiments of the invention. The digital image files IFa1, IFa2, . . . iFaN and IFb1, IFb2, . . . IFbN can be located in one or more databases 202. The database can be any type of known software database product or system. The method can include accessing, querying, or searching the database 202 in block 204 by utilizing one or more database access and searching products. In other embodiments, the files can be retrieved from any other available data source.

For example, in the medical image example, the medical images can be retrieved from a DICOM® viewing workstation, a PACS workstation, and DICOM® data on a CD, DVD or other storage medium. A Picture Archiving and Communications System (PACS) is an industry term for a system of equipment and software that permits radiographic images to be electronically sourced, stored, retrieved, displayed and transmitted for viewing by medical personnel. PACS systems are available from various system suppliers to facilitate the storage and management of DICOM® compliant images. DICOM® is a registered trademark of the National Electrical Manufactures Association for its standards publications that define the format and structure for the digital communications of medical information.

Images can also be stored on centrally located web-based servers accessible using the Internet's standard Transmission Control Protocol/Internet Protocol (TCP/IP). In the medical image application, these web-based servers can include by way of example, a JPG or a DICOM® server. For example, access to information stored on a DICOM® server can be via permissive access, and can require the user to enter a user identification (ID) code and password. Other permissive access techniques can also be used.

The method can also include displaying the contents of the database, which is usually displaying a text description of the file or image contained therein. Also, during the database search process, the images IMa, IMb contained within the image files IFn of the database 202 can be displayed on a display for the operator without having to retrieve that file. In one preferred embodiment, the images IMa, IMb can be highlighted by an operator, but not retrieved, and when highlighted, a thumbnail image of the image IMa and/or IMb is displayed in block 206. In this manner, the operator is presented with a thumbnail image or preview of the image without having to retrieve the entire image file IFn. By way of example, database 202 can contain one or more DICOM® images such that when the operator highlights or places a cursor over the particular file name, description or icon, one or more images contained with the DICOM® image files are previewed by displaying a thumbnail of the image, without retrieving the associated DICOM® image files.

In some embodiments, the method can also include retrieving text files or other files that can be associated with an image file IFn, but not itself contain an image IMn as in block 205. This can also include text data that can be in the same file with an IMn, or one or more other files that can be within a Master File containing the image IMn or image file IFn. In one exemplary embodiment, a retrieved master file can be a directory or a file containing one or more digital medical image files, an XML file, and an HTML file. In such embodiments, the method provides for displaying at least a portion of the contents of the master file as a webpage or individually, or in one or more combinations.

As noted above, generally the method provides for retrieving one or more digital image files from a storage or database containing two or more images having two or more image formats or file formats. In some embodiments, one or more of the retrieved images are converted in 208 from a first format to a second format prior to or in conjunction with creating a working copy of the retrieved image in 106. For example, in one preferred embodiment, each of the retrieved images is converted to a JPEG format in 210 such that each working copy created in 106 is a JPEG formatted image. In another preferred embodiment, one or more or all of the retrieved images are converted to JPEG format unless the retrieved image is already in a JPEG or DICOM® format. In yet other preferred embodiments, when an image is in either a JPG or TIFF format, the image can be converted to either a DICOM® or PDF, or when an image is in either a DICOM® or PDF format, the image is converted to either a JPG or TIFF format. Such conversions can be automatic such as set up by default, or selected by the operator during or associated with an image during retrieval.

Of course in other embodiments, one or more of the retrieved images can be converted into another common image format other than JPEG such that the working copies are in one or more image formats. In other embodiments, each working copy image created there from can be in the native image format consistent with the retrieved image. In some of these embodiments, the images and/or files can be stored in their native format or can be stored in the format to which they were converted. In one preferred format, each working copy or edited image is converted to a common image format and stored in that common image format. This can be beneficial in many situations including an embodiment where two or more images are combined and stored as a single image.

In some embodiments, the system and method can include previewing the working copy or edited image along with the text data, the XML file, and the HTML as a webpage in 212 prior to or in conjunction with creating the directory in 118 and storing the files in the directory in 122. In this manner, an operator can review the edited images and text data as if all or a portion of the created directory is accessed by a third party (not shown) as a webpage. The operator can continue editing or text entry or otherwise prior to the storing of the files in the directory in 122. Similarly, in another embodiment, the contents of a directory that has already been created with stored files, can also be displayed by displaying an HTML and XML version of the stored contents of the directory to simulate the contents as if viewed by an accessing web browser.

In some embodiments, the system and method can also include displaying one or more working copies of images as a thumbnail image to enable the operator to gain ready access or keep track of the retrieved images. The various images that have been retrieved by the operator are shown so that the operator can select each for editing or otherwise without having to remember a title or description by reviewing the thumbnail images and selecting the image by selecting the particular thumbnail image or a header, box or title associated therewith.

In some embodiments, not only are the working copies edited as in 110, but the method and system can provide for annotating an image as in 216 and/or watermark an image as in 218. An operator can annotate a displayed image and initiate one or more annotations to the displayed image in response to an input operation. These can include, but are not limited to, image annotations such as flip right, flip left, flip over, zoom-in, zoom-out, rescaling, contrast, window level, window width, window inversion, and image subtraction. In one preferred embodiment, the annotated image is created by generation of an annotated working copy image that is separate and distinct from the working copy that includes the edits described above, or it can be a separate copy of the edited working copy. Such annotated working copy image can be the file stored or exported or can be stored or exported in conjunction with the other working copy images.

An operator in 218 can create and associate a watermark with one or more working copy images. In another preferred embodiment, the watermark is separately added to the working copy image when the watermarked image is copied, stored or exported, but does not display on the working copy displayed to the operator. A watermark can include a logo, a company name, or the name of the operator. Each watermark can be stored locally, or created on a one time basis. In yet another preferred embodiment, the watermark is automatically inserted or placed on the image or in the image file when the files are saved or exported.

The files to be stored can also be compressed in 220 prior to their storing in 114. Such compression can be any form of file or data compression and can include, but is not limited to, compression by any of the various and generally available file ZIP compression schemes. One or more of the files to be stored can be compressed. Additionally, one or more or portions of any one or more files can also be encrypted to provide various forms of security. For example, a medical application text data that includes patient data can be encrypted to ensure privacy and security. In such cases, an encryption key can be locally provided or created by the local system. In other cases, the key can be provided by a remote system, by the storage medium or a component connected thereto, or received in conjunction with retrieving the images in 205 as a related file or related text data in 112. Additionally, the file or a separate file can be created to include one or more encryption method flags, to provide an indication of the type of encryption utilized to encrypt the files or portions thereof. By way of example, in a medical image context, storing can include storing one or more DICOM® compliant files in which case the encrypting can include encrypting at least a portion of the text data in the DICOM® file such as the patient data. This can be one preferred method when the files are stored in a DICOM® database server or in a web server.

In some embodiments, the created directory and the files are stored on a removable storage medium in 224. Such storage medium can include any removable storage medium including, but not limited to a CD, a DVD, a thumbdrive, and a memory card.

Additionally, a portion or all of the text data can be linked to one or more retrieved images, working copy images, edited images, annotated images, movie files, digital videos, other text data, text data files, or audio clips or files. In one preferred embodiment, the text data is linked to the link image or file by creating a separate file containing the linked text data. In this manner, unlike hyper-linked text, the linked text data and its file is separately maintained and associated with the image or file with which it is linked regardless of any changes to the files, their directory, or one or more communication links. In other embodiments, some or all of a portion of text data or otherwise can also be linked to an image or file using a hyper-link or a similar tag.

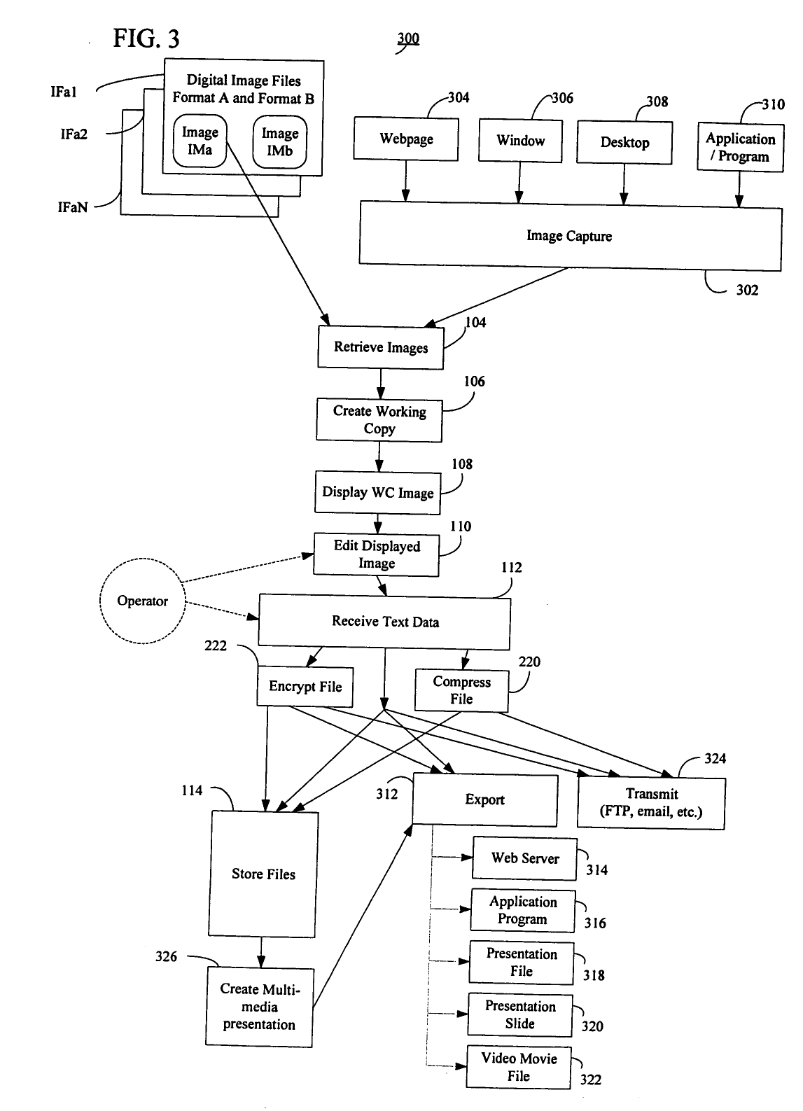

Referring now to FIG. 3, a method and system for digital image management 300 is illustrated that includes various features, some or all of which can be present in one form or another in various embodiments of the invention. As shown, one or more digital image files IFn or digital images IMn can be retrieved in 104. To accomplished image retrieval, a variety of methods and features are available in various embodiments of the invention. For example, one method is the capturing of an image. The image can be captured and retrieved as an imported captured image as shown in 302. The image capture of 302 can be from any variety of image capture systems and methods, some of which are illustrated in FIG. 3.

For example, an image can be captured from a webpage 302 via a web browser (not shown) operating on a computer by an operator. The operator of system 300 can open a webpage in the web browser, and capture or identify an image such as by clicking on an image or highlighting or blocking an image, and import the captured webpage image as a retrieved image in 104. In other image capture methods and systems, the operator can open one or more “windows” 306 or applications or programs 310 on a computer system. Additionally, the operator can have one or more images saved on a desktop 308 of the computer. In one or more of these systems and methods, the operator can select and capture an image contained within the window, application, program or desktop, and retrieve the image in 104. The image capture of 302 can also include one or more of region capture, fix region capture, drag and drop, video capture, and URL extraction. In one preferred embodiment of the system and method of 300, the image capture system and method of 302 is independent of the webpage 304, the web browser, the window 306, the desktop 308, or the application or program 310 or their operating systems, the technology, their format, or otherwise.

By way of example only, when a presentation application program is open and operating on a computer system, one or more slides of the presentation program can include an image that is desired to be retrieved. In such an embodiment, the operator can separate the image from the text contained in the presentation slide, strip out the image, and import the image as a retrieved image in 104. In one preferred embodiment, the presentation application is Microsoft's PowerPoint® presentation application program. In such a case, the operator can separate out the image, strip it from the PowerPoint® slide, and import the stripped image as a retrieved image. In another preferred embodiment, the presentation image such as an image in a PowerPoint® slide is selected by the operator and dragged to a window of a digital image management application and dropped into the application as a retrieved image. As is known to those skilled in the art, other methods of image or other data capture can also be implemented within the scope and aspects of the present invention. As such, various embodiments of the system and method 300 provide the operator with the capability of retrieving images in 104 from many, if not all, computer presented or displayed sources.

As discussed above with regard to FIG. 2, in some embodiments as illustrated again in FIG. 3, one or more images or other files such as text data files, video files, audio files, by way of example, can be compressed in 220 and/or encrypted in 222 in whole or in part, prior to or in conjunction with storing the files in 114.

In some embodiments of the invention, the directory and/or some or all of the images or created files, such as the HTML, XML, retrieved images, working copy images, edited images, annotated images, audio, text data, or video, by way of example, can also be either exported in 312 or transmitted to another system in 324. These can include the encrypted and/or the compressed files, or files that are neither encrypted nor compressed. The files or images can be exported in 312 to any or a variety of export systems utilizing any of a variety of exporting technologies or techniques. FIG. 3 illustrates five exemplary export capabilities that are among the many possible with the current system and method. For example, images, files and/or one or more directories can be exported to a web server 314. In such a manner, the images and files created or managed by the operator can be viewed as a webpage for access and use by third-parties.

As another example, images, files, and/or one or more directories can be exported to an application program 316. For instance, by way of example this can include another active application program such as a word processing application, a spreadsheet program, a drawing program, or a presentation program such as PowerPoint®. The export in 316 addresses exporting to any application program capable of receiving the exported files. Similarly, the export in 318 provides for exporting images, files, or one or more directories to a presentation file such as a file that has previously been created by another application program. In such a case, the exported items can be appended or inserted into the file without the application program for the particular file being open or active. In another export process, images, text data, audio, or video can be exported to a presentation slide in 320. In such a case, one or more images can be placed on a single slide such as stacked images, or they can be allocated one image per slide. For example, a plurality of images can be exported to a PowerPoint® slide and be stacked on a single PowerPoint® slide. Such exported slides can be exported in an operator defined format or size. In yet another embodiment, images, text data, and/or audio can be exported to generate a video movie file in 322. The generated video movie file 322 can be generated in any known video format and can include, AVI, GIF, and MPEG files formats, by way of example. In such embodiment, two or more images are combined to form the video movie.

As discussed above, the images or any of the files can be transmitted from the system and method 300 to another system or process. Such transmission can be provided via any type of communication technology and is not generally limited by the technology. In one preferred embodiment, the directory or files contained therein, or images can be transmitted via a file transfer protocol (FTP) via a telecommunication or data communication interface to another system or process. In another preferred embodiment, the directory or files contained therein can be emailed over a network, such as an Internet, LAN, or WAN, to a system or user at an operator defined or default email address. In this manner, the operator can share or communicate either all or a portion of the images, audio, video, or text data, with one or more other parties.

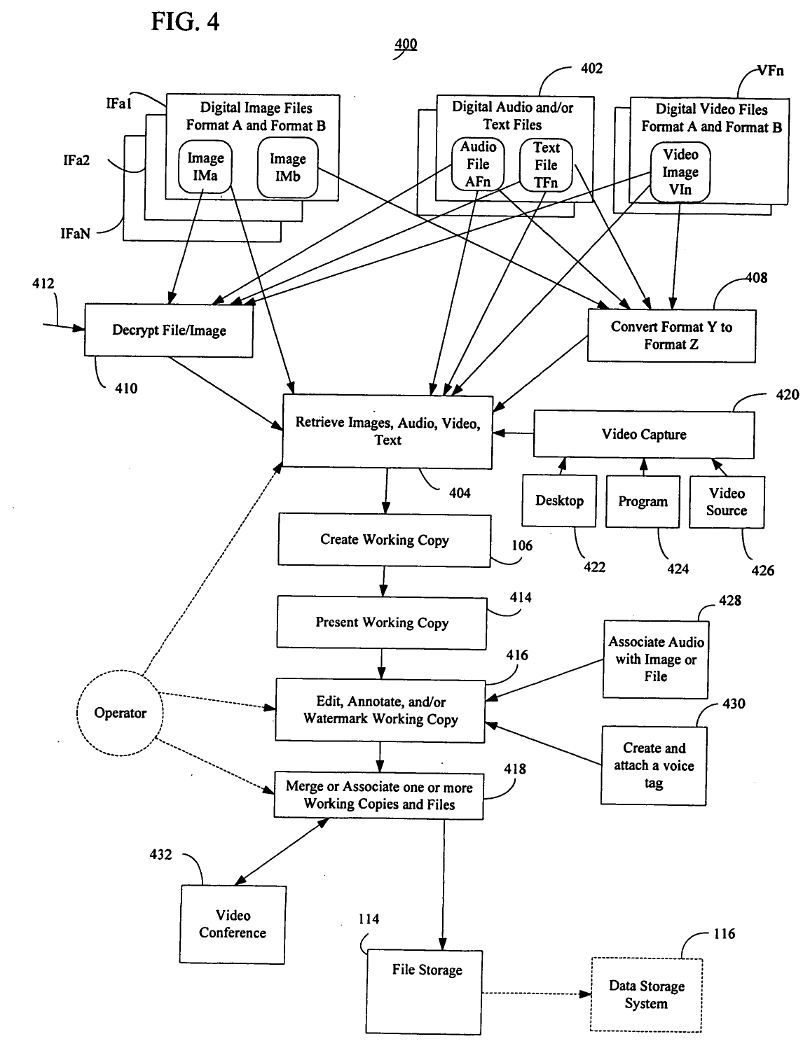

Referring now to FIG. 4, a method and system for digital image management 400 is illustrated that includes various features, some or all of which, can be present in one form or another in various embodiments of the invention. As discussed above, one or more images IMn can be retrieved by method and system 400 from a plurality of images IMn or image files IFn having two or more formats. In the exemplary embodiment of FIG. 4, one or more digital audio files AFn and/or text data files TFn 402 can also be retrieved in 404. Additionally, one or more digital video files VFn can also be retrieved in 404.

In the embodiment where an audio file AFn is retrieved, as will be discussed later, an audio sound can be generated from the audio file. Additionally, the audio file AFn can be copied, edited, annotated, and audio watermarked, similar to the above discussion related to images, except in an audio form and format. The audio file AFn when retrieved can be one of a wide variety of audio formats and can include, by way of example, ASF, ASX, MPEG Audio Layer, MP2, MP3, and WAV audio formats. Additionally, the method and system 400 can also include an audio input, such as a microphone, for retrieving/receiving audio input from the operator. In this manner, the operator can input audio narrative or music into the method and system 400 to be edited, associated, and/or merged with one or more images, audio files, text data, and/or digital videos. By way of example, one of the retrieved audio files or audio received from an operator can be used to create a voice tag containing the received voice input or audio files. The voice tag can then be attached to a portion or an entire edited image or text data file. In this manner, the method and system 400 enables an operator to add voice or music to any created multimedia output containing one or more of the retrieved images IMn.

Similarly, one or more text files TFn can be retrieved in 404. Additionally, a text file TFn can also be associated with or included in a digital file from a retrieved image IMn, a retrieved audio file AFn, or a retrieved digital video file VFn. As discussed above, the text data can be edited or used to edit an image or image file and can be stored in the directory in 114. One or more digital video files VFn having one or more video formats can also be retrieved by 404. These can include digital video formats such as GIF, AVI, MPEG1, MPEG2, MPEG 4, and WMF, by way of example.

Additionally, when one or more of the audio files AFn, text files TFn, or video files VFn are in a format that is less than desirable, or is not a predetermined, preferred or common format, each can be converted from the native format to a desired or predetermined format in conjunction with retrieving the file as indicated in 408. For example, an AVI file can be converted to MPEG1 or MPEG2 formats, a MPEG1 can be converted to an AVI format, or a MPEG2 file can be converted to AVI format depending on the needs of the operator. In this manner, the method and system 400 can search and find any file in any format and retrieve the file while still being able to perform any desired or necessary manipulation, editing, annotation, merger, and combination to one or more files. Similarly, where an audio file AFn, a text file TFn, or a video file VFn is encrypted in whole or in part, the file can be decrypted in 410 in conjunction with retrieving the file in 404. Such decryption is typically accomplished by using one or more decryption keys. In one preferred embodiment of the present invention, the method and system 400 received an encryption key in 412 when the method and system 400 receives a system license or license key. In this manner, each method and system 400 is authorized to decrypt certain files as a function of its license, such as its software license. This can provide an added level of security to not only the method and system 400 but also to any files that are retrieved by an operator or stored by an operator. In another embodiment, the encryption key and decryption key and or encryption method for one or more images IMn, audio files AFn, text files TFn, and video files TFn can be determined from the file itself, such as a tag, or metadata, by way of example.

In some embodiments of the invention, method and system 400 can capture video in 420 similar to that described above with regard to image capture in FIG. 3. Capturing a video in 420 can include capturing all or a portion of a desktop 422, a program running or operating on a computing device 424, or from a video source 426 such as a camera, computer display, a video conference, and video players, by way of example. Each captured video in 420 becomes a retrieved video file in 404.

In each case, after each image, audio,.text, and video file is retrieved in 404 and a working copy of the audio, text, and video file can be created in addition to the retrieved file itself in 404. In this manner, a working copy of each can be created in 106 for presentation in the appropriate format to the operator in 414. Once presented to the operator in 414, the system and method enables the operator to edit, annotate, and/or watermark the presented image, audio, text or video in 416. Additionally, two or more images, audio, text, and/or videos can be merged, combined, or associated by the operator in 418. As such, a working copy, retrieved copy, edited copy, and/or annotated copy of an image, audio, text, and/or video can be stored in file storage 114 with the directory and in the data storage system 116.

The method and system 400 can also provide a video, messaging (such as Instant Messaging), and/or audio conferencing capability to the operator in 432. In this manner, the operator can open conferencing with other operators or third-parties during operation of the method and system 400 to enable the operator to utilize their input. For example, a video conference can be created between two persons who are collaborating on a project such as the preparation of a presentation for a meeting. Each person can provide input into the retrieving of images, audio, text, and video, into the editing, annotating, or watermarking of the files and into generating the output such as storing or exporting. The desktop displays of each can be displayed for the other party and a portion or all of the conference can be captured and saved as a file to be included as a captured image, text, audio, or video file to be included, combined, or associated with one or more files, in whole or in part.

As discussed above, in some embodiments one or more files can be associated with one or more other files. For example, in 428 an audio, such as a voice input from the operator or from an audio or video conference can be associated with an image, or image file, text data, or video file. Additionally, a tag can be created in 430 to include the audio and the tag can be attached to the image, image file, text data, or video file. In this manner, the audio can be played back with the image, text or video thereby providing narration or comments.

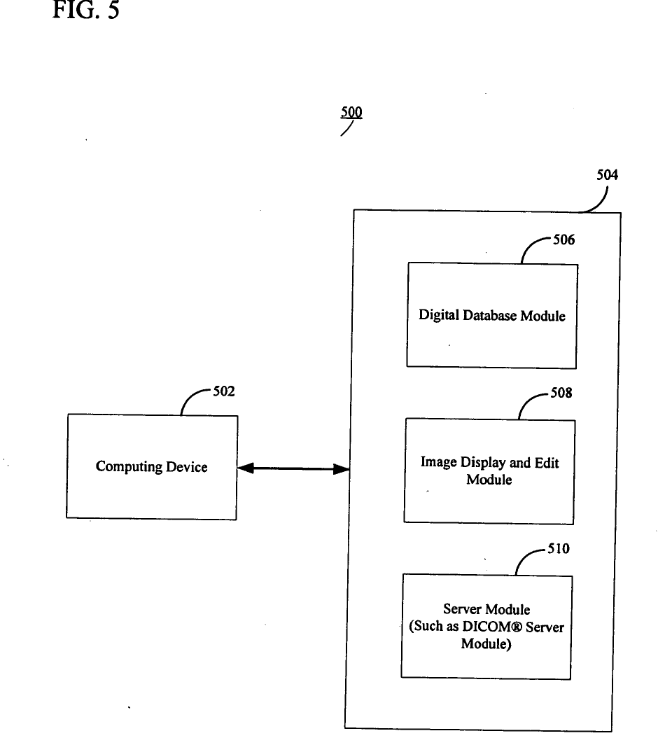

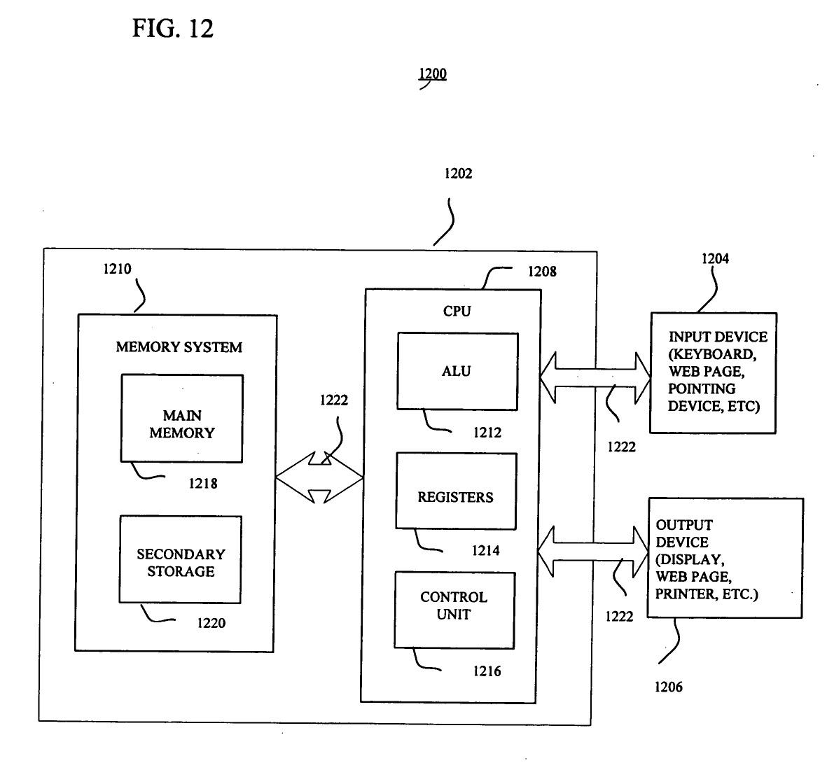

Referring now to FIG. 5, a digital image asset management system 500 is illustrated that includes a computing device 502 and one or more software programs 504 that can include a plurality of software modules. The computing device 502 is described in more detail in regard to FIG. 12 below. The software modules can include, by way of example, a digital database module 506, an image display and edit module 508, and a server module 510. More or fewer software modules can be utilized to implement the various embodiments of the invention as described herein. Additionally, the features and functions of the digital image management system various embodiments as described above with regard to FIGS. 1-4 can be combined in a variety of combinations of more or fewer software modules and still are consistent with the scope of the invention.

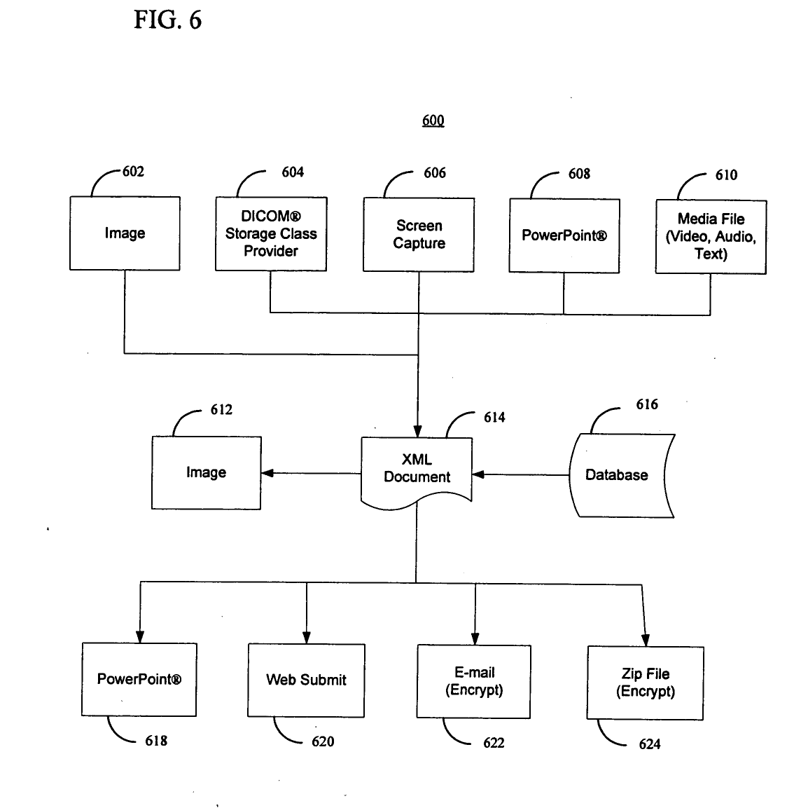

FIG. 6 provides one exemplary software module architecture for a digital asset management system and method 600 according to another exemplary embodiment of the invention. In exemplary system and method 600, one or more images 602 are retrieved. This can be by accessing a DICOM® storage class provider's database 604 for a medical application or similar database for another application, by screen capture 606 as by one or more of the methods described above, from a PowerPoint® in 608 or other presentation or application or program as described above, or from a media file 610. These retrieve files and/or images are edited, annotated, and/or watermarked and an XML file or document is created in 614. The XML document is stored in a database 616 and generally provides for viewing one or more images or other files in 612, for example, as described above with regard to previewing the XML document prior to storing. The directory or various files can be exported to a PowerPoint® slide, a program or a file in 618, can be submitted to a web server in 620 for posting on the web, or can be emailed, transmitted, or otherwise transferred to another system or party in 622. Additionally, as many of these files can be large, one or more files of the directory can be compressed, such as with a ZIP file, or encrypted in 624 prior to transmitting or filing.

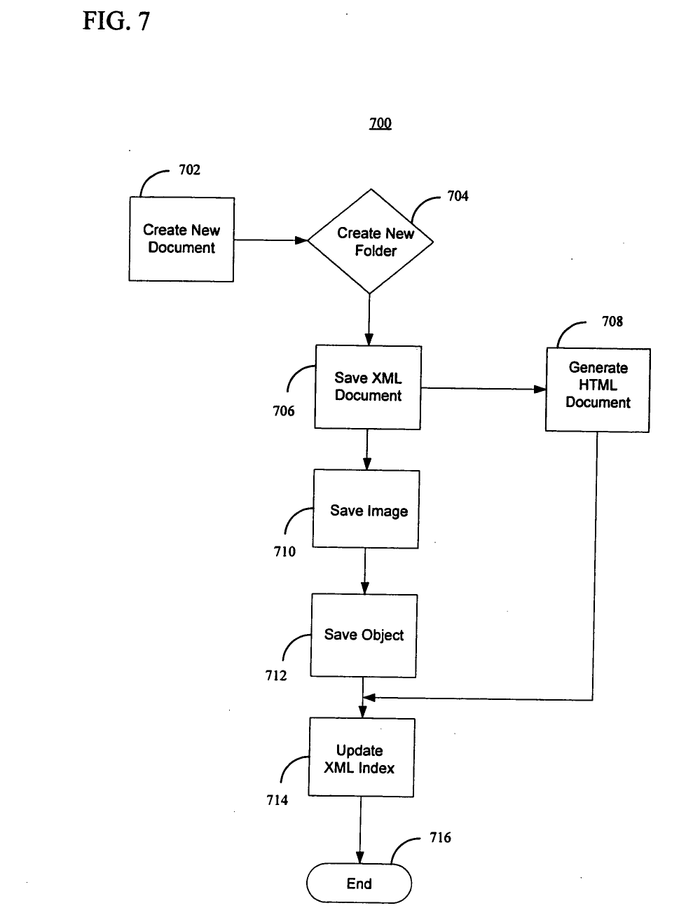

FIG. 7 provides a flow diagram of a database hierarchy and process flow 700 for a digital image asset management system according to another exemplary embodiment of the invention. The method 700 starts when a new document is created in 702. The new document typically contains a plurality of files including working copies of images, text data, audio files, and/or video files. A new directory or folder is automatically created in 704 in a database or other storage medium. The XML file or document is created and saved in 706 with the HTML document being created in 708. One or more images, audio files, text data, and/or videos are saved in 710 and one or more are saved as objects in 712. The objects of 712 and the HTML document from 708 are combined and the XML index is updated to complete the database method in 716.

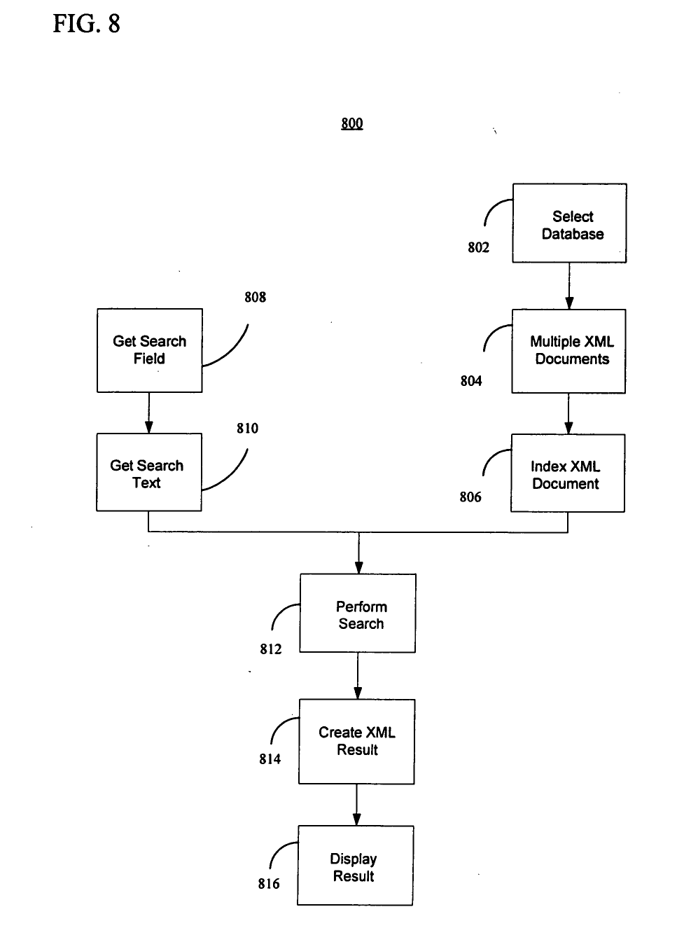

FIG. 8 provides a flow diagram of a database search process 800 for a digital image asset management system according to one exemplary embodiment of the invention. The database search process 800 includes selecting a database in 802 which is often one or many databases from which to choose. In 804, multiple XML documents are identified in the selected database and one or more XML documents are indexed in 806. A search field is entered or retrieved in 808 with the search text being obtained in 810. A search of one or more databases as a function of the search text is performed in 812 and an XML document or file is created in 814 containing the results of the search. The results of the search are displayed to the operator in 816.

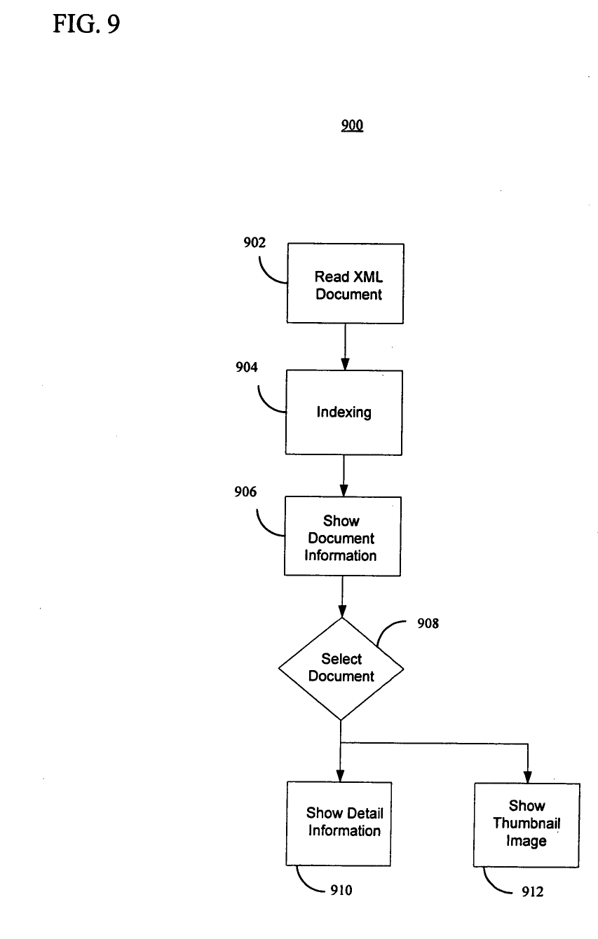

FIG. 9 is one exemplary flow diagram of a database management process 900 for a digital image asset management system according to some exemplary embodiments of the invention. In process 900, the XML document is read in 902 and is indexed in 904. The document information is displayed to the operator in 906. The operator selects one or more of the documents displayed in 906 by pointing or otherwise highlighting the one or more documents. Each document can contain one or more images, text data, audio files, and video files. When the operator selects the one or more documents, the detailed information related to the selected documents is displayed in 910 and a thumbnail image of each image contained within the selected document is displayed to the operator in conjunction with the detail information. In this manner, the operator is presented with not only the detail information related to the highlighted, and un-retrieved document, but also with a thumbnail image of the images contained therein without having to open or retrieve the entire document or file. This provides the operator with the ability to preview the contents of the highlighted documents to enable them to have the images presented before a decision has to be made as to whether or not to retrieve the entire document or file.

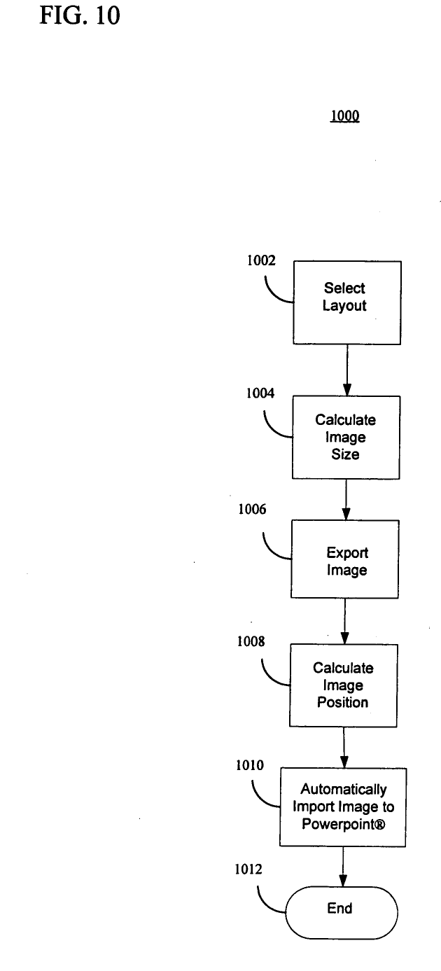

FIG. 10 is an exemplary flow diagram of an exporting process 1000 for exporting to a presentation application for a digital image asset management system according to some embodiments of the invention. The process 1000 starts with presenting a plurality of layouts to the operator and having the operator select a particular layout in 1002. The system calculates the image size in 1004 based on the working copies of images currently active in the desktop or as selected by the operator. After the image size is calculated, the image is exported in 1006. The image position is calculated in 1008 and the image is automatically imported to a PowerPoint® or other presentation program or application in 1010 to end the exporting process in 1012.

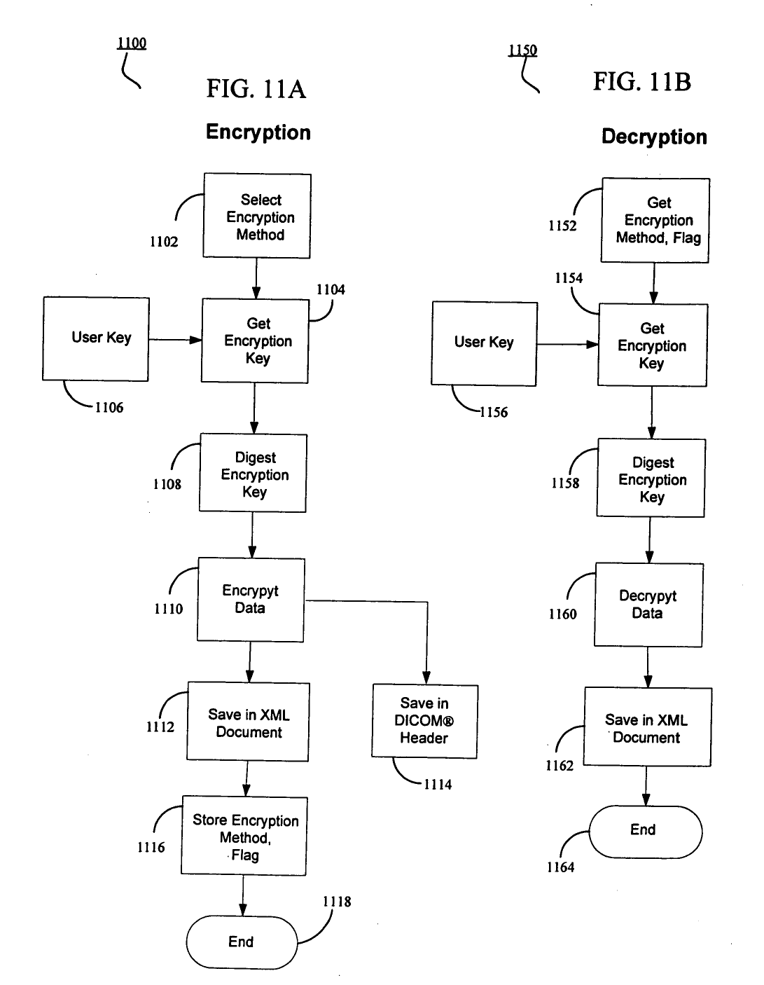

FIGS. 11A and 11B illustrate exemplary flow diagrams of encryption process 1100 and decryption processes 1150, respectively, for a digital image asset management system according to some embodiments of the invention. The encryption process 1100 starts with the selection of the encryption method in 1102. The selection can be predetermined, by default or selected by the operator. An encryption key is obtained in 1104. As discussed above, the encryption key can be entered by the operator, or received from another source, such as from the license or user key 1106 for the digital image management system. The encryption key is analyzed or digested in 1108 and once complete, all or a portion of the text data associated with one or more images or with the directory is encrypted in 1110. The encrypted data is saved in a file header, such as a DICOM® header, or is saved in a tag, a separate file, or as metadata in 1114. The encrypted text data is then stored in the XML document in 112 and the encryption method or flag is also stored in a file or within the directory. The encryption method 1100 ends in 1118, when the encryption process is complete.

FIG. 11B illustrates one exemplary embodiment of the decryption method 1150. The method starts in 1152 with the obtaining of the encryption method or flag within a directory or otherwise that is associated with a file to be retrieved or that has been retrieved. The encryption key is obtained, typically from a local source that has been provided to the operator or the operators system. As discussed above, this key provides security to the text data portion of the director and files and the key is generally provided on a need to know or at least a limited basis. The user key can be obtained, in one preferred embodiment, from the operator or user license. After the key is obtained, the encryption key is digested or evaluated in 1158 and used to decrypt text or other encrypted data associated with a file to be retrieved or one that has been retrieved in 1160. The decrypted data is saved in an XML document in 1162 for local use by the operator. The decryption process ends at 1164.

These are only a few of the exemplary processes associated with the methods and systems that are shown in the exemplary embodiment of the invention in FIGS. 1-4. Other detailed processes can also be developed by one skilled in the art.

Referring now to FIG. 12, an operating environment for an exemplary embodiment of the invention is a computer system 1200 with a computer 1202 that comprises at least one high speed processing unit (CPU) 1208, in conjunction with a memory system 1210, an input device 1204, and an output device 1206. These elements are interconnected by at least one bus structure 1222. These computing elements interact to provide an operating environment for digital image asset management and/or exchange according to the various embodiments of the invention.

The illustrated CPU 1208 is of familiar design and includes an arithmetic logic unit (ALU) 1212 for performing computations, a collection of registers 1214 for temporary storage of data and instructions, and a control unit 1216 for controlling operation of the system 1200. Any of a variety of processors, including at least those from Digital Equipment Corporation (DEC), SUN Microsystems, MIPS, Motorola, NEC, Intel, Cyrix, Advanced Micro Devices, Hewlett Packard, and Nexgen, are equally preferred for the CPU 1208. The illustrated embodiment of the invention operates on an operating system designed to be portable to any of these processing platforms.

The memory system 1210 generally includes high-speed main memory 1218 in the form of a medium such as random access memory (RAM) and read only memory (ROM) semiconductor devices, and secondary storage 1220 in the form of long term storage mediums such as floppy disks, hard disks, tape, CD-ROM, flash memory, etc. and other devices that store data using electrical, magnetic, optical or other recording media. The main memory 1218 also can include video display memory for displaying images through a display device. Those skilled in the art will recognize that the memory system 1210 can comprise a variety of alternative components having a variety of storage capacities.

The input and output devices 1204 and 1206 are familiar to those skilled in the art. The input device 1204 can comprise a keyboard, a mouse, a scanner, a pointing device, a touch pad, a communication link, and/or a physical transducer such as a microphone. The output device 1206 can comprise a display, a printer, a transducer (e.g. a speaker), etc. Some devices, such as a network adapter or a modem, can be used as input and/or output devices.

As is familiar to those skilled in the art, the computer system 1200 further includes an operating system and at least one application program. The operating system is the set of software which controls the computer system's operation and the allocation of resources. The methods and system described herein are applicable to a wide range of operating systems including, by way of example, Microsoft® Windows® XP, UNIX®, Macintosh®, and LINUX®. The application program is the set of software that performs a task desired by the user, using computer resources made available through the operating system. This can include one or more database application programs. Both are resident in the illustrated memory system 1210.

In accordance with the practices of persons skilled in the art of computer programming, the present invention is described below with reference to symbolic representations of operations that are performed by the computer system 1200. Such operations are sometimes referred to as being computer-executed. It will be appreciated that the operations which are symbolically represented include the manipulation by the CPU 1208 of electrical signals representing data bits and the maintenance of data bits at memory locations in the memory system 1210, as well as other processing of signals. The memory locations where data bits are maintained are physical locations that have particular electrical, magnetic, or optical properties corresponding to the data bits. Various embodiments of the invention can be implemented in a program or programs, comprising a series of instructions stored on a computer-readable medium. The computer-readable medium can be any of the devices, or a combination of the devices, described above in connection with the memory system 1210.

One or more embodiments of the invention as described above and in the figures of the various exemplary embodiments can provide for one or more technical effects related to a reduction in the time and resources required to perform digital asset management as described above. Some embodiments can provide for improved efficiency of digital image management and management of associated text, audio, and video and the editing, annotating, and/or watermarking of each, and the combining, integration, and/or association of one or more of each of these in a directory. Once compiled by the various embodiments of the system and method of the invention, the contents of the directory can be stored for future reference and access, can be published as a webpage, can be exported to a wide variety of application and systems, and can be transmitted to remote systems and applications.

While the system and method described herein address the automation of methods and procedures associated with digital asset management including image management and by way of one example, medical image management, it should be clear to one skilled in the art that the various embodiments of the invention can also be applied or implemented to a variety of other tasks, methods, and procedures associated with a variety of technologies and industries. For example, the present method and procedure can also be implemented with manufacturing, design, operational, regulatory, and engineering methods and systems that utilize analysis programs or modules and that can benefit access to one or more databases or otherwise stored data. As such, the various embodiments can include embodiments related to any field or industry, and is not limited to medical images as described herein by way of example.

It should be known to those skilled in the art, that one or more exemplary embodiments of the present invention can be implemented or recorded as a computer readable medium containing computer executable instructions for performing the method and implementing one or more components of the system described above.

As should also be known to those skilled in the art, one or more exemplary embodiments described herein have identified various processes, methods, modules, sub-modules, and functions. It should be understood that fewer or more processes, modules and sub-modules may be implemented and still be within the scope of the invention. Additionally, some modules identified as separate modules herein can be implemented as functions of other modules, and or functions may be implemented as a separate module. The identification of the various modules is only exemplary in nature and is not intended to be limiting.

When describing elements or features of the present invention or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the invention. Accordingly, all matter contained in the above description or shown in the accompanying drawings should be interpreted as illustrative and not in a limiting sense.

It is further to be understood that the steps described herein are not to be construed as necessarily requiring their performance in the particular order discussed or illustrated. It is also to be understood that additional or alternative steps may be employed.

What is claimed is:

1. A method of managing digital medical images, the method comprising:
retrieving one or more digital medical images from among a plurality of digital medical image files, said plurality of digital medical image files having medical images formatted in two or more different image file formats;
creating a working copy image of each of the retrieved digital medical images;
displaying one or more working copy images;
editing one or more displayed images responsive to an input from an operator, said displayed images including the edits;
receiving text data associated with one or more edited images;
automatically creating a directory in a database associated with the one or more edited images and the text data;
automatically generating an XML file and an HTML file associated with the directory; and
storing the edited images, the text data, the XML file, and the HTML file in the directory.

2. The method of claim 1 wherein the text data includes at least one of patient data, case data, subject data, test data, diagnostic data, DICOM® data, and research data.

3. The method of claim 1 wherein the medical images are images selected from the group consisting of an XRAY, an MRI, a CT scan, a Nuclear Medicine study, an ultrasound scan, a laser scan, a PET scan, an endoscope image, a microscope image, an electron microscope image, an electrocardiogram (EKG), an electro encephalogram (EEG), and electro myogram (EMG), audiometry/audiogram, and an optical scan.

4. The method of claim 1 wherein the operator is associated with one or more of a radiologist, a radiation oncologist, a cardiologist, an oncologist, a surgeon, a dermatologist, a pathologist, an internist, a medical researcher, a pharmacist, a dentist, an ophthalmologist, a drug developer, a physician, and a student.

5. A computer readable medium having computer executable instructions for performing the method of claim 1.

6. The method of claim 1 wherein creating a working copy image includes converting at least one retrieved digital medical image to a working copy image in a JPEG format when the retrieved image is not a JPEG or DICOM® formatted image.

7. The method of claim 6 wherein storing includes combining each of the common formatted working copy images into a single image, said single image being stored.

8. The method of claim 1 wherein the two or more digital medical image files include image file formats selected from the group of formats consisting of JPEG, PNG, PSD, BMP, TIFF, DICOM®, DICOM® secondary capture, PDF, Run-Length Encoding, Multiframe DICOM®, and Microsoft PowerPoint®.

9. The method of claim 1, further comprising displaying a thumbnail image of an image within a stored image file prior to retrieving an image file containing the image.

10. The method of claim 1, further comprising searching a database containing one or more DICOM® images, wherein displaying includes previewing the DICOM® images contained in the database as thumbnails without retrieving the associated DICOM® image files.

11. The method of claim 1 wherein displaying the retrieved images includes displaying at least one working copy image as a thumbnail image as viewed in the database.

12. The method of claim 1, further comprising accessing a storage system containing the plurality of digital medical image files and searching the storage system for the plurality of digital medical image files, wherein retrieving includes retrieving the one or more digital medical images from the storage system.

13. The method of claim 12 wherein the storage system includes a database, said accessing and searching including querying the database.

14. The method of claim 1, further comprising converting at least one working copy image from a first format to a second format.

15. The method of claim 14 wherein the first format is at least one of JPG and TIFF and the second format is DICOM®.

16. The method of claim 14 wherein the first format is DICOM® and the second format is at least one of JPG and TIFF.

17. The method of claim 1, further including watermarking at least one working copy image in response to operator input, wherein the watermark is separately added to the working copy image when the watermarked image is copied or exported.

18. The method of claim 1 wherein one of the retrieved image files is a DICOM® file, further comprising automatically extracting text data from the DICOM® file tag, wherein receiving includes the received text data including the extracted text data from the DICOM® file tag.

19. The method of claim 1, further comprising linking at least a portion of the text data to an image or image file, wherein linking includes creating a separate file containing the linked text data and wherein storing includes storing a copy of the linked text data file in the directory.

20. The method of claim 1, further comprising highlighting a portion of the linked text data and linking an image or image file to the highlighted text.

21. The method of claim 1, further comprising displaying an HTML and XML version of the stored contents of the directory to simulate the contents as if viewed by an accessing web browser.

22. The method of claim 1 wherein storing includes encrypting, at least a portion, of the text data in the database as a function of an encryption key and storing the encryption method flag.

23. The method of claim 1, further comprising retrieving a master file stored in a database, said master file including one or more digital medical image files, an XML file, and an HTML file, wherein displaying includes displaying at least a portion of the contents of the master file.

24. The method of claim 1, further comprising exporting the directory to a web server for hosting a webpage containing an XML, XHTML, or HTML version of one or more of the files stored in the database.

25. The method of claim 1, further comprising exporting one or more of the edited images or retrieved images to another application program.

26. The method of claim 25 wherein the application program is PowerPoint® by Microsoft®.

27. The method of claim 26 wherein exporting includes at least one of exporting multiple displayed images and stacking the multiple exported images on a single PowerPoint® slide.

28. The method of claim 1 wherein retrieving at least one of the images includes capturing an image viewed or associated with another application and importing the captured image as one of the retrieved images.

29. The method of claim 28 wherein capturing an image is selected from the group consisting of desktop capture, open window, region capture, fix region capture, drag and drop, video capture, webpage extraction, and URL extraction.

30. The method of claim 28 wherein retrieving includes separating out an image from text of a PowerPoint® slide, stripping the image from a PowerPoint® slide, and dragging and dropping the stripped image.

31. The method of claim 28 wherein retrieving includes dragging and dropping an image located on a PowerPoint® slide to a window of a digital image management application in response to operator interaction.

32. The method of claim 1, further comprising communicating to an email address one or more contents of the database.

33. The method of claim 1, further comprising generating a video movie file from the two or more single frame images, wherein storing includes storing the generated video movie file.

34. The method of claim 1, further comprising creating a multi-media presentation file from the contents of the directory stored in the database.

35. The method of claim 34 wherein converting is at least one of converting an AVI file to MPEG1 or MPEG2, converting a MPEG1 file to AVI, and converting a MPEG2 file to AVI.

36. The method of claim 1, further comprising receiving the system license key including a decryption key via an email communication to an email address associated with the operator.

37. The method of claim 1, further comprising at least one of video capturing of the desktop of a display screen, video capturing of a software program, video capturing in real time of a video source, and video conferencing.

38. The method of claim 1, further comprising retrieving a digital video, wherein creating a working copy includes creating a working copy video from the retrieved digital video, displaying includes displaying the working copy video, and storing includes storing the working copy video in the database.

39. The method of claim 37 wherein the digital video includes a video image having a format selected from the group consisting of GIF, AVI, MPEG1, MPEG2, MPEG 4, and WMF.

40. The method of claim 1 wherein storing includes encrypting, at least a portion, of the text data in the database as a function of an encryption key and storing the encryption method flag.

41. The method of claim 40 wherein the storing includes storing as a DICOM® file and wherein encrypting includes encrypting at least a portion of the text data in the DICOM® file.

42. A system for managing digital medical images, comprising:
a general purpose computing device; and
a computer program including program modules executable by the computing device, said program modules including;
a digital database module for automatically creating and maintaining a database containing a plurality of directories, each of the directories having a plurality of associated files including a digital medical image file containing one or more digital medical images, an XML file, and an HTML file, said plurality of directories having a plurality of digital medical images formatted in two or more different image file formats;
an image display and edit module for displaying at least one digital medical image retrieved from the digital database module, editing the at least one displayed image in response to input from an operator, and generating an output file including one or more of the edited images; and
a digital imaging and communication in medicine (DICOM®) server module for reading and composing DICOM® compliant formatted files, and retrieving and storing images and text contained therein.

43. The system of claim 42 wherein said general purpose computing device includes a processor, a storage device, a display, a user interface, and a communication interface, said storage device being configurable, at least in part, as a database.

44. The system of claim 42 wherein the one or more digital medical images are images selected from the group consisting of an XRAY, an MRI, a CT scan, a Nuclear Medicine study, an ultrasound scan, a laser scan, a PET scan, an endoscope image, a microscope image, an electron microscope image, an electrocardiogram (EKG), an electro encephalogram (EEG), and electro myogram (EMG), audiometry/audiogram, and an optical scan.

45. The system of claim 42 wherein the plurality of digital medical image files contained in the plurality of directories include two or more formats selected from the group of formats consisting of JPEG, PNG, PSD, BMP, TIFF, DICOM®, DICOM® secondary capture, PDF, Run-Length Encoding, Multiframe DICOM®, and Microsoft PowerPoint®.

46. The system of claim 42 wherein said multi-media digital database module includes a database search tool enabling a user to search the database for one or more images.

47. The system of claim 42 wherein the image display and editing module is configured to generate an output file or image compatible with PowerPoint®.

48. A system for managing digital medical images, comprising:
a general purpose computing device including a display and user input device; and
a computer program including computer executable instructions configured for retrieving one or more digital medical images from among a plurality of digital medical image files, said plurality of digital medical image files having medical images formatted in two or more different image file formats, one of which is a digital imaging and communication in medicine (DICOM®) formatted file, creating a working copy image of each of the retrieved digital medical images, displaying at least one digital medical images, editing one or more displayed images responsive to an input from an operator, receiving text data associated with one or more edited images including data from a DICOM® formatted file, automatically creating a directory in a database associated with the one or more edited images and the text data, automatically generating an XML file and an HTML file associated with the directory, and storing the edited images, the text data, the XML file, and the HTML file in the directory.
